(19) United States
(12) Patent Application Publication
(10) Pub. No.: US 2023/0079717 A1
(43) Pub. Date: Mar. 16, 2023

(54) BATTERY PACK AND ELECTRICAL DEVICE

(71) Applicant: Dongguan Poweramp Technology Limited, Dongguan City (CN)

(72) Inventors: Fanggui Peng, Dongguan City (CN); Shenbo Wang, Dongguan City (CN)

(73) Assignee: Dongguan Poweramp Technology Limited, Dongguan City (CN)

(21) Appl. No.: 17/992,504

(22) Filed: Nov. 22, 2022

Related U.S. Application Data
(63) Continuation of application No. PCT/CN2021/088974, filed on Apr. 22, 2021.

(30) Foreign Application Priority Data
May 27, 2020 (CN) 202020930967.0

(51) Int. Cl. H01M 50/284; H01M 50/209; H01M 50/503; H01M 50/516; H01M 50/262; H01M 50/55; H01M 10/48; H01M 50/583; H01M 10/44

(52) U.S. Cl. CPC H01M 50/284; H01M 50/209; H01M 50/503; H01M 50/516; H01M 50/262; H01M 50/55; H01M 10/482; H01M 10/486; H01M 50/583; H01M 10/441; H01M 2200/103

(57) ABSTRACT

A battery pack includes: a housing, in which an accommodation space is made available; a cell module, accommodated in the accommodation space, and including a plurality of stacked cells, each cell comprises a cell housing, a first tab and a second tab, and the tabs extend out of the accommodation space; an adapter board, disposed on the cell module, where the first tab and the second tab are welded onto the adapter board; a circuit board, where the circuit board is arranged adjacent to the adapter board; a first connecting strip, one end is connected to the first tab, another end is connected to a positive input end of the circuit board; and a second connecting strip, one end is connected to the second tab, another end of is connected to a negative input end of the circuit board.

### CROSS-REFERENCE TO RELATED APPLICATIONS

The present application is a continuation application of PCT application PCT/CN2021/088974, filed on 22 Apr. 2021, which claims priority to Chinese Patent Application No. 202020930967.0, filed on 27 May 2020, both of which are hereby incorporated by reference in its entirety.

### TECHNICAL FIELD

This application relates to the technical field of batteries, and in particular, to a battery pack and an electrical device.

### BACKGROUND

A battery is a device that contains an electrolyte solution and metal electrodes and that converts chemical energy into electrical energy through the electrolyte solution and the metal electrodes. A single battery is usually unable to meet requirements of the electrical device. Therefore, a plurality of batteries are usually connected in series to form a battery pack for use. For example, a plurality of cylindrical 18650 cells or 21800 cells are connected in series to form a battery pack.

In a process of implementing this application, the applicant of this application finds that when a battery pack is formed by connecting cylindrical 18650 cells or 21800 cells in series, if any two of the cylindrical cells are arranged side by side, spacing exists between the two small-unit cylindrical cells. The battery pack made of such cylindrical cells is not space-efficient, results in a low energy density per unit volume, and is inconvenient to use.

### SUMMARY

To solve the foregoing technical problem, some embodiments of this application provide a conveniently usable battery pack and electrical device.

Some embodiments of this application employ the following technical solution to solve the technical problem:

A battery pack includes: a housing, a cell module, an adapter board, a circuit board, a first connecting strip, and a second connecting strip, the housing having an accommodation space, the cell module is accommodated in the accommodation space, and includes a plurality of stacked cells. Each cell includes a cell housing, a first tab and a second tab. The first tab and the second tab extend out of the accommodation space. The adapter board is disposed on the cell module. The first tab and the second tab are welded onto the adapter board. The circuit board is fixed onto the housing. The circuit board is arranged adjacent to the adapter board. The first connecting strip is disposed on the housing. One end of the first connecting strip is connected to the first tab. Another end of the first connecting strip is connected to a positive input end of the circuit board. The second connecting strip is disposed on the housing. One end of the second connecting strip is connected to the second tab. Another end of the second connecting strip is connected to a negative input end of the circuit board.

Optionally, a fixing assembly is disposed on the housing. The fixing assembly includes a first clasp and a second clasp. The first clasp and the second clasp are clasped to the circuit board and the connecting strip respectively.

Optionally, the fixing assembly further includes a fixing board. A limiting post extends from one end of the fixing board. A toothed portion extends from another end of the fixing board away from the housing. The toothed portion, the fixing board, and the limiting post together form an opening. A lateral end of the circuit board is clasped into the opening.

Optionally, a first groove and a second groove are disposed on the housing. The first connecting strip is accommodated in the first groove. The second connecting strip is accommodated in the second groove.

Optionally, the first connecting strip and the second connecting strip each include a bend portion. A clearance exists between the adapter board and the housing. The bend portion is disposed in the clearance.

Optionally, The cell housing includes a body portion and an outward extension portion obtained by extending one end of the body portion. The first tab and the second tab are connected to the outward extension portion. A stacking direction of the plurality of stacked cells is a first direction. Along the first direction, a distance is provided between the outward extension portion and two ends of the body portion so that an accommodation space is formed at a junction between the body portion and the outward extension portion. The bend portion is partly located in the accommodation space.

Optionally, shapes of the bend portion include a U shape or a V shape.

Optionally, the first connecting strip includes a first portion and a second portion. One end of the first portion is connected to one end of the bend portion. Another end of the first portion is connected to the adapter board. One end of the second portion is connected to another end of the bend portion. Another end of the second portion is connected to the circuit board. A first clearance is provided between one end of the bend portion and the adapter board. A second clearance is provided between another end of the bend portion and the body portion.

Optionally, the battery pack includes a sampling line. An accommodation slot is made on a lateral face of the housing. The sampling line is accommodated in the accommodation slot. One end of the sampling line is connected to the circuit board, and another end of the sampling line is connected to the adapter board.

Optionally, the battery pack further includes a thermistor welded to the adapter board. An accommodation hole is made in the adapter board. The thermistor is accommodated in the accommodation hole.

Optionally, the battery pack further includes a fuse. The fuse connects the second connecting strip and the second tab; or, the fuse connects the first connecting strip and the first tab.

Optionally, a safety slot is made in the adapter board. The fuse includes a fusing portion. The fuse is disposed on the adapter board.

Optionally, the housing includes a top board and two lateral boards. The two lateral boards are connected to the top board to form the accommodation space. The top board is disposed oriented toward end faces of the plurality of cells and perpendicular to a first direction. The two lateral boards are connected to two opposite ends of the top board. The first direction is a stacking direction of the plurality of cells.

Optionally, the adapter board includes a plurality of openings, the openings are configured for the tabs of the cell to protrude.

Optionally, the circuit board is connected to the adapter board, and is configured to control charging or discharging of the cell module.

Optionally, the circuit board is disposed on one side of the top board away from the accommodation space.

Optionally, the bend portion extends out of the accommodation space.

Optionally, the sampling line is a flexible circuit board.

Optionally, the first connecting strip is connected to the first side of the adapter board, the second connecting strip is connected to the second side of the adapter board, the first side is opposite to the second side in the second direction, the plurality of stacked cells are stacked along a first direction, the second direction is perpendicular to first direction.

Some embodiments of this application further employ the following technical solution to solve the technical problem:

An electrical tool is provided, including the foregoing battery pack.

Beneficial effects of some embodiments of this application are: The battery pack according to some embodiments of this application includes a housing, a cell module, an adapter board, a circuit board, a first connecting strip, and a second connecting strip. An accommodation space is made available in the housing. The cell module is accommodated in the accommodation space, and includes a plurality of stacked cells. The cell module includes a first tab and a second tab. The first tab and the second tab extend out of the accommodation space. The adapter board is disposed on the cell module. The first tab and the second tab are welded onto the adapter board. The circuit board is fixed onto the housing. The circuit board is arranged adjacent to the adapter board. The first connecting strip is disposed on the housing. One end of the first connecting strip is connected to the first tab. Another end of the first connecting strip is connected to a positive input end of the circuit board. The second connecting strip is disposed on the housing. One end of the second connecting strip is connected to the second tab. Another end of the second connecting strip is connected to a negative input end of the circuit board. Through the foregoing structure, a plurality of cells are closely stacked. The battery pack made in this way achieves a high energy density per unit volume and is more convenient to use.

### BRIEF DESCRIPTION OF DRAWINGS

One or more embodiments are described illustratively with reference to drawings corresponding to the embodiments. The illustrative description does not constitute any limitation on the embodiments. Components marked with the same reference numeral in the drawings represent similar components. Unless otherwise specified, the drawings do not constitute any scale limitation.

FIG. 1 is a schematic structural diagram of a battery pack according to an embodiment of this application;

FIG. 2 is a structural exploded view of FIG. 1;

FIG. 3 is a schematic structural diagram of a housing shown in FIG. 2;

FIG. 4 is a schematic structural diagram of a cell module shown in FIG. 1;

FIG. 5 is a structural exploded view of a cell body shown in FIG. 2;

FIG. 6 is a schematic structural diagram of a connecting strip shown in FIG. 2;

FIG. 7 is a schematic diagram of FIG. 1 viewed from another angle;

FIG. 8 is a schematic structural diagram of a part of FIG. 7; and

FIG. 9 is a schematic structural diagram of a fuse shown in FIG. 2.

### DETAILED DESCRIPTION

For ease of understanding this application, the following describes this application in more detail with reference to drawings and specific embodiments. It is hereby noted that an element referred to herein as “fixed to” another element may directly exist on the other element, or may be fixed to the other element through one or more intermediate elements. An element referred to herein as “connected to” another element may be connected to the other element directly or through one or more intermediate elements. A direction or a positional relationship indicated by the terms such as “up”, “down”, “in”, “out”, “vertical”, and “horizontal” used herein is a direction or positional relationship based on the illustration in the drawings, and is merely intended for ease or brevity of describing this application, but does not indicate or imply that the indicated device or component is necessarily located in the specified direction or constructed or operated in the specified direction. Therefore, such terms are not construed as a limitation on this application. In addition, the terms “first” and “second” are merely used for descriptive purposes, but not construed as indicating or implying relative importance.

Unless otherwise defined, all technical and scientific terms used herein have the same meanings as what is normally understood by a person skilled in the technical field of this application. The terms used in the specification of this application are merely intended to describe specific embodiments but not to limit this application. The term “and/or” used herein is intended to include any and all combinations of one or more related items preceding and following the term.

In addition, to the extent that no mutual conflict occurs, the technical features described below and mentioned in different embodiments of this application may be combined with each other.

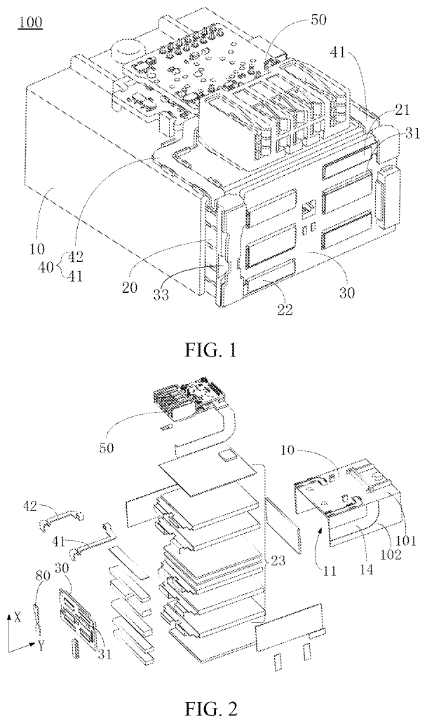

As shown in FIG. 1 to FIG. 2, a battery pack 100 according to an embodiment of this application includes a housing 10, a cell module 20, an adapter board 30, a connecting strip 40, and a circuit board 50. An accommodation space 11 is made available in the housing 10. The cell module 20 is accommodated in the accommodation space 11. The cell module 20 includes a plurality of stacked cells. The cell module 20 includes a first tab 21 and a second tab 22. The first tab 21 and the second tab 22 extend out of the accommodation space 11. The adapter board 30 is disposed on the cell module 20. The first tab 21 and the second tab 22 are welded onto the adapter board 30. The connecting strip 40 is disposed on the housing 10, and includes a first connecting strip 41 and a second connecting strip 42. One end of the first connecting strip 41 is connected to the first tab 21. Another end of the first connecting strip 41 is connected to a positive input end of the circuit board 50. One end of the second connecting strip 42 is connected to the second tab 22. Another end of the second connecting strip 42 is connected to a negative input end of the circuit board 50. The circuit board 50 is fixed onto the housing 10. The circuit board 50 is connected to the adapter board 30, and is configured to control charging or discharging of the cell module 20.

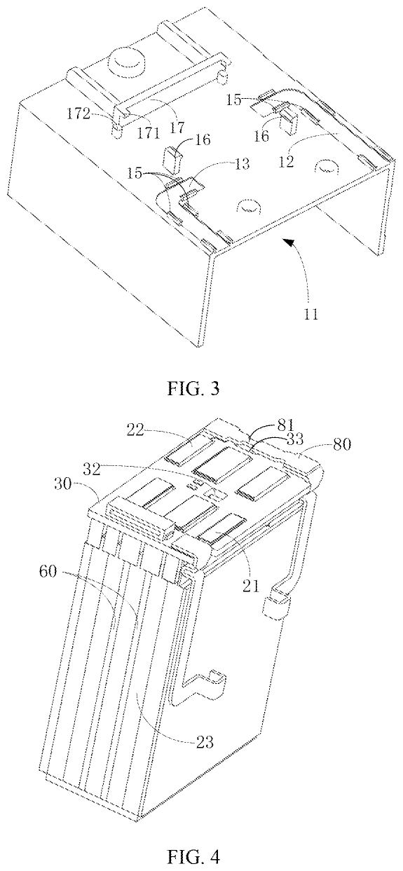

Referring to FIG. 3, the housing 10 is formed by at least three boards that close in. Two opposite ends of one board are connected to one end of each of the other two boards to form the accommodation space 11. Definitely, one end of the housing 10 is necessarily in communication with the outside, so that other parts of the battery pack 100 can be mounted into the housing 10. In this embodiment, as shown in FIG. 2, the housing 10 includes a top board 101 and two lateral boards 102. The two lateral boards 102 are connected to the top board 101 to form the accommodation space 11. The top board 101 is disposed oriented toward end faces of the plurality of cells and perpendicular to a first direction. The first direction is a stacking direction of the plurality of cells, such as the direction X shown in FIG. 2. The two lateral boards 102 are connected to two opposite ends of the top board 101. The shape of the housing 10 is a U-shaped block. Two opposite ends of the housing 10 communicate with the outside. Alternatively, merely one end of the housing 10 communicates with the outside, as long as the housing 10 is able to accommodate other parts.

Further, a first groove 12, a second groove 13, and an accommodation slot 14 are disposed on the housing 10. The first connecting strip 41 is mounted in the first groove 12, and the second connecting strip 42 is mounted in the second groove 13. Understandably, the first groove 12 and the second groove 13 may be located on the same end face of the housing 10, or may be located on two end faces of the housing 10 respectively. In this embodiment, both the first groove 12 and the second groove 13 are located on the top board 101 of the housing 10, the accommodation slot 14 is located on the lateral board 102 of the housing 10, and the accommodation slot 14 is located on a surface adjacent to a surface on which the first groove 12 and the second groove 13 are located. Therefore, a user may mount the connecting strip 40 by positioning the connecting strip into the first groove 12 or the second groove 13 first, and then mount the connecting strip conveniently.

In some embodiments, a fixing assembly (not shown) is disposed on the housing 10. The fixing assembly is mounted on the housing 10. The fixing assembly is configured to fixedly mount the circuit board 50 and the connecting strip 40 onto the housing. In this embodiment, the fixing assembly fixes the circuit board 50 and the connecting strip 40 in the form of a clasp. Specifically, the fixing assembly includes a first clasp 15 and a second clasp 16. The first clasp 15 and the second clasp 16 are clasped to the connecting strip 40 and the circuit board 50 respectively, so that the circuit board 50 and the connecting strip 40 are fixedly mounted onto the housing 10.

Understandably, the fixing assembly may be symmetrically arranged torsion springs instead of the two clasps that fit each other. When the fixing assembly is a torsion spring, an L-shaped bump is disposed on the housing 10 correspondingly. The torsion spring sheathes one end of the bump. One end of the torsion spring abuts on an end face of the housing 10, and another end of the torsion spring abuts on one end of the circuit board 50 or the connecting strip 40. Understandably, another bump and another torsion spring are disposed at another end of the circuit board 50 or the connecting strip 40 correspondingly. In practical use, the fixing can be implemented only through coordination between both sides. Definitely, the fixing assembly may be other structures than the two forms mentioned above, as long as the fixing assembly can fixedly mount the first connecting strip 41, the second connecting strip 42, and the circuit board 50 onto the housing 10.

Referring to FIG. 3 again, in some embodiments, the fixing assembly further includes a fixing board 17 fixed to the housing 10. A limiting post 171 extends from one end of the fixing board 17. A toothed portion 172 extends from another end that is of the fixing board 17 and that is away from the housing. The toothed portion 172, the fixing board 17, and the limiting post 171 together form an opening. A lateral end of the circuit board 50 is clasped into the opening. In this way, the circuit board 50 is fixed to the housing 10.

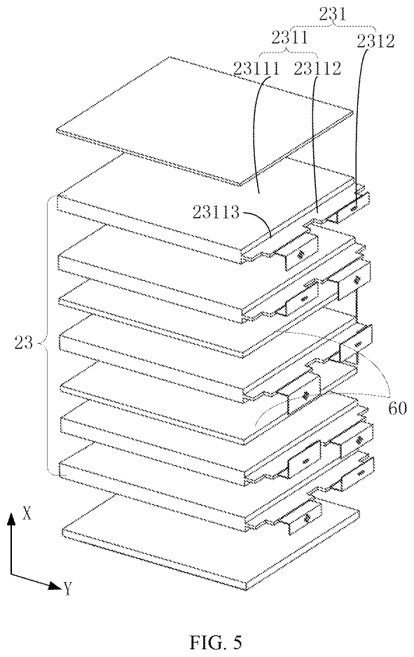

Referring to FIG. 1, FIG. 4, and FIG. 5, the cell module 20 includes a first tab 21, a second tab 22, a cell body 23. One end of the cell body 23 is connected to the first tab 21 and the second tab 22.

The cell body 23 is formed by stacking a plurality of cells 231 in a preset stacking manner. Each cell 231 includes a positive tab and a negative tab. When a plurality of cells 231 are connected in series, the stacking manner is: the negative tab of the cell located at the top of the cell module 20 abuts on the positive tab of a next cell, and the negative tab of the next cell is connected to the positive tab of a second next cell, and so on, until the positive tab of a bottom cell is connected to the negative tab of the previous cell, thereby implementing series connection between the cells. At this time, the positive tab of the top cell is the first tab 21 of the cell module 20, and the negative tab of the bottom cell is the second tab 22 of the cell module 20. For ease of understanding, three cells are used as an example for description here. Specifically, the cell body 23 includes a first cell, a second cell, and a third cell. Two opposite end faces of the second cell abut on one end face of the first cell and one end face of the third cell. In this case, the negative tab of the first cell abuts on the positive tab of the second cell, and the negative tab of the second cell abuts on the positive tab of the third cell, so that the first cell, the second cell, and the third cell are connected in series.

Alternatively, the preset stacking manner may be: The positive tab and negative tab of the cell located at the top of the cell module 20 abut on the positive tab and negative tab of the next cell in one-to-one correspondence, and the positive tab and negative tab of the next cell are connected to the positive tab and negative tab of the previous cell in one-to-one correspondence, and so on, thereby implementing parallel connection between the cells. In this embodiment, the cells of the cell module 20 are connected in series.

It is hereby noted that the shape of the cell 231 may be prismatic, or may be a shape formed by combining arc parts at both ends and a prismatic part in the middle, or may be another shape.

In some embodiments, the cell 231 includes a cell housing 2311 and a tab 2312. The cell housing 2311 includes a body portion 23111 and an outward extension portion 23112 obtained by extending one end of the body portion 23111. The tab 2312 is connected to the outward extension portion 23112. Along the first direction X, a distance is reserved between the outward extension portion 23112 and at least one of two opposite end faces of the body portion 23111 so that an accommodation space 23113 is formed at a junction between the body portion 23111 and the outward extension portion 23112. The accommodation space 23113 is approximately L-shaped. Preferably, a distance is reserved between the outward extension portion 23112 and each of the two opposite end faces of the body portion 23111, the outward extension portion 23112 extends along an approximately middle position of one end of the body portion 23111, and the body portion 23111 is thicker than the outward extension portion 23112.

In some embodiments, the battery pack 100 further includes a filler (not shown). The filler is mounted between the cell body 23 and the adapter board 30. Understandably, the filler may fill an excess space between the cell body 23 and the adapter board 30 to prevent dust from entering the cell body 23. Definitely, the filler also prevents the tabs from directly contacting each other after being deformed under an extrusion force, where the direct contact leads to a short circuit of the cell body 23. In this embodiment, the filler is insulation foam.

In some embodiments, the battery pack 100 further includes a cushion (not shown). The cushion is mounted between the housing 10 and the cell body 23. Understandably, the cushion may surround and wrap the remaining end faces of the cell body 23 other than the end face on which the tabs are located, or may surround just a part of the end faces of the cell body 23. Understandably, when the housing is squeezed, the cushion can alleviate the squeezing force exerted by the housing 10 on the cell body 23, and prevent the housing 10 from directly squeezing and deforming the cell body 23. The cushion may be foam or another material that serves a cushioning function. In this embodiment, the cushion is foam.

On the adapter board 30, a plurality of openings 31 are made. The openings 31 are configured for the tabs of the cell module 20 to protrude, so as to enable the connecting strip 40 to connect the circuit board 50 and the cell module 20.

In some embodiments, the adapter board 30 further includes an accommodation hole 32 and a safety slot 33, and the battery pack 100 further includes a thermistor (not shown). The thermistor is welded onto the adapter board 30, and the thermistor is accommodated in the accommodation hole 32. Understandably, when the thermistor is accommodated in the accommodation hole 32, a temperature sensed by the thermistor is the temperature of the cell module 20, so that the circuit board 50 can obtain a more accurate temperature.

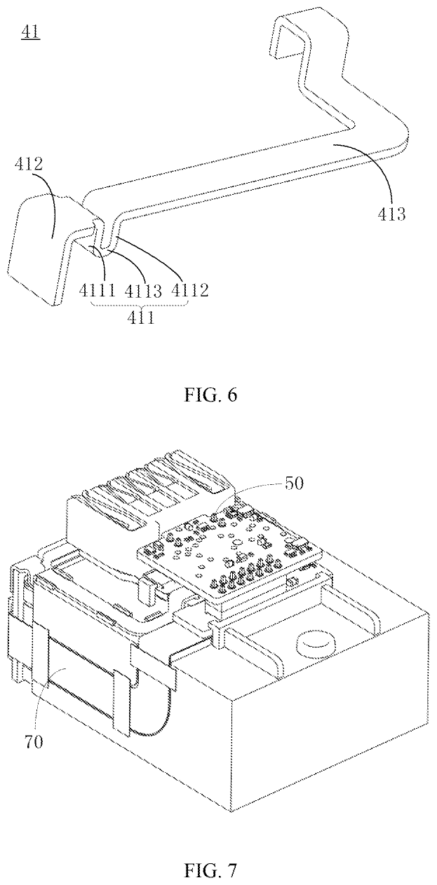

Referring to FIG. 1 and FIG. 6, the connecting strip 40 includes the first connecting strip 41 and the second connecting strip 42. The first connecting strip 41 and the second connecting strip 42 each include a bend portion 411. The bend portion 411 is partly located in the accommodation space 23113. A clearance is reserved between the adapter board 30 and the housing 10. The shape of the bend portion 411 may be a U shape, a V shape, or another shape.

When the connecting strip 40 is connected to the circuit board 50 and the adapter board 30, the bend portion 411 is located between the adapter board 30 and the cell body 23, thereby improving stability of the battery pack 100.

To facilitate readers' understanding of how the connecting strip 40 improves the stability of the battery pack, the following gives the details by using the first connecting strip 41 as an example:

The first connecting strip 41 further includes a first portion 412 and a second portion 413 in addition to the bend portion 411. One end of the first portion 412 is connected to one end of the bend portion 411, and another end of the first portion 412 is connected to the adapter board 30. One end of the second portion 413 is connected to another end of the bend portion 411, and another end of the second portion 413 is connected to the circuit board 50. The bend portion 411 includes a first connecting portion 4111, a second connecting portion 4112, and an arc portion 4113. Two ends of the arc portion 4113 are connected to the first connecting portion 4111 and the second connecting portion 4112 respectively. The first connecting portion 4111 is connected to the first portion 412. The second connecting portion 4112 is connected to the second portion 413. The arc portion 4113 is located between the adapter board 30 and the body portion 23111. An extending direction of the outward extension portion 23112 against the body portion 23111 is a second direction, such as the direction Y shown in FIG. 2 or FIG. 5. Along the second direction Y, a first clearance exists between the first connecting portion 4111 and the end face of the adapter board 30, and a second clearance exists between the second connecting portion 4112 and the body portion 23111.

The structure of the second connecting strip 42 is identical to the structure of the first connecting strip 41, details of which are omitted here.

Understandably, when the adapter board 30 vibrates under a force, the bend portion 411 is expandable. The first clearance provides space for the bending portion 411 to expand, exerts some effect of cushioning, and reduces the probability that a bonding pad connected to the first connecting strip 41 is detached by an external pulling force when the adapter board 30 is stressed, thereby improving the firmness of the connection between the first connecting strip 41 and the adapter board 30. Similarly, the second clearance also provides space for the bend portion 411 to expand, exerts some effect of cushioning, and reduces the probability of damage or detachment at a junction between the second portion 413 and the circuit board 50.

Understandably, the first connecting strip 41 and the second connecting strip 42 are made of a conductive material. Preferably, the first connecting strip 41 and the second connecting strip 42 are made of copper.

In some embodiments, the battery pack 100 further includes a phase transition material layer 60. The phase transition material layer 60 is disposed between two cells. Understandably, the phase transition material layer 60 is primarily configured to absorb heat generated during operation of the cell, so as to prevent the cell from overheating and causing the battery pack 100 to explode.

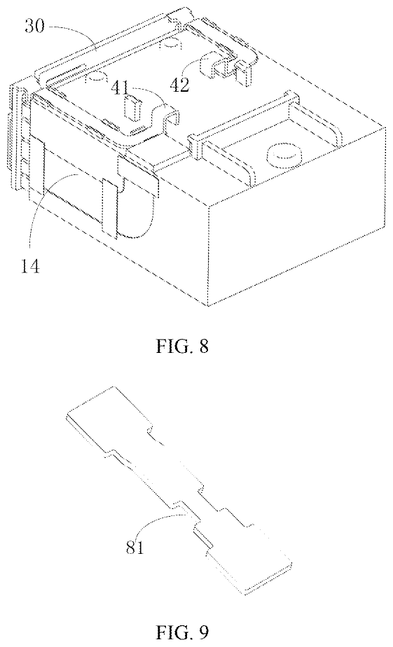

As shown in FIG. 7 and FIG. 8, in some embodiments, the battery pack 100 further includes a sampling line 70. The sampling line 70 is detachably mounted in the accommodation slot 14. One end of the sampling line 70 is connected to the circuit board 50, and another end is connected to a collection circuit located on the adapter board 30 and configured to collect data of the cell module 20. In this embodiment, the sampling line 70 adopts a flexible circuit board, so as to fit the housing more suitably and make the structure of the battery pack 100 more compact. Understandably, in order to firmly mount the sampling line 70 in the accommodation slot 14, the sampling line 70 may be fixed by adhesive tape or glue or other means.

Referring to FIG. 4 and FIG. 9, in some embodiments, the battery pack 100 further includes a fuse 80. On the one hand, the fuse 80 may be connected to the second connecting strip 42 and the second tab 22. That is, one end of the fuse 80 is connected to one end of the second connecting strip 42, another end of the fuse 80 is connected to the second tab 22, and the second connecting strip 42 is connected to the second tab 22 through the fuse 80. On the other hand, the fuse 80 may be connected to the first connecting strip 41 and the first tab 21 instead. That is, one end of the fuse 80 is connected to one end of the first connecting strip 41, and another end of the fuse is connected to the first tab 21. In this embodiment, the two ends of the fuse 80 are connected to the second connecting strip 42 and the second tab 22 respectively.

Further, the fuse 80 includes a fusing portion 81. The fusing portion 81 is a part with a smallest cross-sectional area in the fuse 80. Understandably, according to R=ρl/s, the smaller the cross-sectional area, the larger the resistance value of the part, and correspondingly, the larger the amount of heat emitted, and the more prone the part is to blow out. When overcurrent occurs, the fuse 80 blows out to break the circuit and ensure safety to some extent. Understandably, waste (such as sparks) may be generated after the fusing portion 81 fuses off. In order to prevent the waste from falling into the accommodation space, the fuse 80 is disposed on the adapter board 30, and the fusing portion 81 is located above the safety slot 33, so that the waste generated after fusing of the fusing portion 81 is accommodated in the safety slot 33 conveniently.

In some embodiments, the battery pack 100 further includes a first conductive sheet (not shown) and a second conductive sheet (not shown). The first conductive sheet and the second conductive sheet are located at two ends on the same side of the adapter board 30 respectively. Two ends of the first conductive sheet are connected to the first tab 21 and the first connecting strip 41 respectively. Two ends of the second conductive sheet are connected to the second tab 22 and the fuse 80 respectively.

The battery pack 100 according to an embodiment of this application includes a housing 10, a cell module 20, an adapter board 30, a connecting strip 40, and a circuit board 50. An accommodation space 11 is made available in the housing 10. The cell module 20 is accommodated in the accommodation space 11, and includes a plurality of stacked cells. The cell module 20 includes a first tab 21 and a second tab 22. Both the first tab 21 and the second tab 22 extend out of the accommodation space 11. The adapter board 30 is disposed on the cell module 20. Both the first tab 21 and the second tab 22 are welded onto the adapter board 30. The connecting strip 40 is disposed on the housing 10, and includes a first connecting strip 41 and a second connecting strip 42. One end of the first connecting strip 41 is connected to one end of the first tab 21. Another end of the first connecting strip 41 is connected to a positive input end of the circuit board 50. One end of the second connecting strip 42 is connected to one end of the second tab 22. Another end of the second connecting strip 42 is connected to a negative input end of the circuit board 50. The circuit board 50 is fixed onto the housing 10. The circuit board 50 is contiguous to the adapter board 30, and is configured to control charging or discharging of the cell module 20. Through the foregoing structure, a plurality of cells are closely stacked, and the internal space of the battery pack is utilized sufficiently. The battery pack made in this way achieves a high energy density per unit volume and is more convenient to use.

An electrical device according to another embodiment of this application includes the battery pack 100 according to the foregoing embodiment.

What is described above is merely some embodiments of this application, and does not limit the patent scope of this application in any way. All equivalent structural variations and equivalent process variations made by using the content of the specification and the drawings of this application, and the content hereof used directly or indirectly in other related technical fields, still fall within the patent protection scope of this application.

We claim:

1. A battery pack, comprising:
a housing having an accommodation space;
a cell module accommodated in the accommodation space, and comprising a plurality of stacked cells; wherein each cell comprises a cell housing, a first tab and second tab; and the first tab and the second tab extend out of the accommodation space;
an adapter board disposed on the cell module, wherein the first tab and the second tab are welded onto the adapter board;
a circuit board fixed onto the housing, wherein the circuit board is arranged adjacent to the adapter board;
a first connecting strip disposed on the housing, wherein one end of the first connecting strip is connected to the first tab, and another end of the first connecting strip is connected to a positive input end of the circuit board; and
a second connecting strip disposed on the housing, wherein one end of the second connecting strip is connected to the second tab, and another end of the second connecting strip is connected to a negative input end of the circuit board.

2. The battery pack according to claim 1, wherein a fixing assembly is disposed on the housing, the fixing assembly comprises a first clasp and a second clasp, and the first clasp and the second clasp are clasped to the circuit board and the connecting strip respectively.

3. The battery pack according to claim 2, wherein the fixing assembly further comprises a fixing board; a limiting post extends from one end of the fixing board, and a toothed portion extends from another end of the fixing board away from the housing; the toothed portion, the fixing board, and the limiting post together form an opening; and a lateral end of the circuit board is clasped into the opening.

4. The battery pack according to claim 1, wherein a first groove and a second groove are disposed on the housing, the first connecting strip is accommodated in the first groove, and the second connecting strip is accommodated in the second groove.

5. The battery pack according to claim 1, wherein the first connecting strip and the second connecting strip each comprise a bend portion, a clearance exists between the adapter board and the housing, and the bend portion is disposed in the clearance.

6. The battery pack according to claim 5, wherein, the cell housing comprises a body portion and an outward extension portion obtained by extending one end of the body portion, the first tab and the second tab are connected to the outward extension portion, a stacking direction of the plurality of stacked cells is a first direction, and, along the first direction, a distance is provided between the outward extension portion and two end faces of the body portion so that an accommodation space is formed at a junction between the body portion and the outward extension portion, and the bend portion is partly located in the accommodation space.

7. The battery pack according to claim 6, wherein shapes of the bend portion comprise a U shape or a V shape.

8. The battery pack according to claim 6, wherein the first connecting strip comprises a first portion and a second portion, one end of the first portion is connected to one end of the bend portion, another end of the first portion is connected to the adapter board, one end of the second portion is connected to another end of the bend portion, another end of the second portion is connected to the circuit board, a first clearance is provided between one end of the bend portion and the adapter board, and a second clearance is provided between another end of the bend portion and the body portion.

9. The battery pack according to claim 1, wherein the battery pack comprises a sampling line, an accommodation slot is made on a lateral face of the housing, the sampling line is accommodated in the accommodation slot, one end of the sampling line is connected to the circuit board, and another end of the sampling line is connected to the adapter board.

10. The battery pack according to claim 1, wherein the battery pack further comprises a thermistor welded to the adapter board, an accommodation hole is made in the adapter board, and the thermistor is accommodated in the accommodation hole.

11. The battery pack according to claim 1, wherein the battery pack further comprises a fuse, the fuse connects the second connecting strip and the second tab; or, the fuse connects the first connecting strip and the first tab.

12. The battery pack according to claim 11, wherein a safety slot is made in the adapter board, the fuse comprises a fusing portion, and the fuse is disposed on the adapter board.

13. The battery pack according to claim 1, wherein the housing comprises a top board and two lateral boards, the two lateral boards are connected to the top board to form the accommodation space, the top board is disposed oriented toward end faces of the plurality of cells and perpendicular to a first direction, the two lateral boards are connected to two opposite ends of the top board, and the first direction is a stacking direction of the plurality of cells.

14. The battery pack according to claim 1, wherein the adapter board comprises a plurality of openings, the openings are configured for the tabs of the cell to protrude.

15. The battery pack according to claim 1, wherein the circuit board is connected to the adapter board, and is configured to control charging or discharging of the cell module.

16. The battery pack according to claim 1, wherein the circuit board is disposed on one side of the top board away from the accommodation space.

17. The battery pack according to claim 5, wherein the bend portion extends out of the accommodation space.

18. The battery pack according to claim 9, wherein the sampling line is a flexible circuit board.

19. The battery pack according to claim 1, wherein the first connecting strip is connected to the first side of the adapter board, the second connecting strip is connected to the second side of the adapter board, the first side is opposite to the second side in the second direction, the plurality of stacked cells are stacked along a first direction, the second direction is perpendicular to first direction.

20. An electrical device, wherein the electrical device comprises the battery pack according to claim 1.
